(19) United States
(12) Patent Application Publication
(10) Pub. No.: US 2020/0282882 A1
(43) Pub. Date: Sep. 10, 2020

(54) SEAT AIR CONDITIONER

(71) Applicant: DENSO CORPORATION, Kariya-city (JP)

(72) Inventors: Masafumi KAWASHIMA, Kariya-city (JP); Shuji ITO, Kariya-city (JP); Hironobu MURAKAMI, Kariya-city (JP); Takahisa FUJII, Kariya-city (JP)

(21) Appl. No.: 16/883,535

(22) Filed: May 26, 2020

Related U.S. Application Data
(63) Continuation of application No. PCT/JP2018/039029, filed on Oct. 19, 2018.

(30) Foreign Application Priority Data
Nov. 28, 2017 (JP) 2017-228112

(51) Int. Cl. B60N 2/56

(52) U.S. Cl. CPC B60N 2/5657; B60N 2/5685

(57) ABSTRACT

A seat air conditioner is disposed in a seat pad for supporting a seated person and includes an airflow sheet. The airflow sheet is formed in a sheet-like shape and defines an air passage therein. The airflow sheet has an air hole that opens toward a seat surface when the airflow sheet is disposed in the seat pad. Furthermore, the airflow sheet generates heat when energized.

### CROSS REFERENCE TO RELATED APPLICATIONS

This application is a continuation application of International Patent Application No. PCT/JP2018/039029 filed on Oct. 19, 2018, which designated the U.S. and claims the benefit of priority from Japanese Patent Application No. 2017-228112 filed on Nov. 28, 2017. The entire disclosure of all of the above applications is incorporated herein by reference.

### TECHNICAL FIELD

The present disclosure relates to a seat air conditioner.

### BACKGROUND ART

As a blower unit mounted in a seat of an automobile or the like, a blower described has been known. Such a blower unit has a blowing source and an air passage. The air passage is formed in a sheet-like shape by arranging a plurality of thermoplastic elastomer tubes in parallel to be integrally formed. The air passage is connected to a blowing source via a nozzle. A plurality of slit-shaped outlets are formed on the upper surface (i.e., on the seat cover) of the plurality of tubes constituting the air passage.

When the air blower is incorporated into a vehicle seat of an automobile, the sheet-like air passage is disposed between the seat pad and the seat cover. In addition, a seat heater can be provided between the sheet-like air passage and the seat cover.

### SUMMARY

According to one aspect of the present disclosure, a seat air conditioner is disposed in a seat pad for supporting a seated person and includes an airflow sheet that is formed in a sheet-like shape and defines an air passage therein. The airflow sheet has an air hole that opens toward a seat surface when the airflow sheet is disposed in the seat pad. Furthermore, the airflow sheet generates heat when energized.

### BRIEF DESCRIPTION OF DRAWINGS

FIG. 1 is a diagram schematically showing an entire configuration of a seat air conditioner according to an embodiment.

FIG. 2 is an exploded perspective view showing a seat pad shown in FIG. 1.

FIG. 3 is a side cross-sectional view showing a schematic configuration of one modification to the seat air conditioner shown in FIG. 1.

FIG. 4 is a side cross-sectional view showing a schematic configuration of another modification to the seat air conditioner shown in FIG. 1.

FIG. 5 is a side cross-sectional view showing a schematic configuration of yet another modification to the seat air conditioner shown in FIG. 1.

FIG. 6 is a cross-sectional view showing a schematic configuration of one modification to an airflow sheet shown in FIG. 1.

FIG. 7 is a cross-sectional view showing a schematic configuration of another modification to the airflow sheet shown in FIG. 1.

FIG. 8 is a plan view showing a schematic configuration of yet another modification to the airflow sheet shown in FIG. 1.

FIG. 9 is a cross-sectional view taken along line IX-IX in FIG. 8.

FIG. 10 is a side cross-sectional view showing a schematic configuration of one modification to a terminal in FIG. 1.

FIG. 11 is a side cross-sectional view showing a schematic configuration of another modification to the terminal in FIG. 1.

### DESCRIPTION OF EMBODIMENTS

### Embodiment

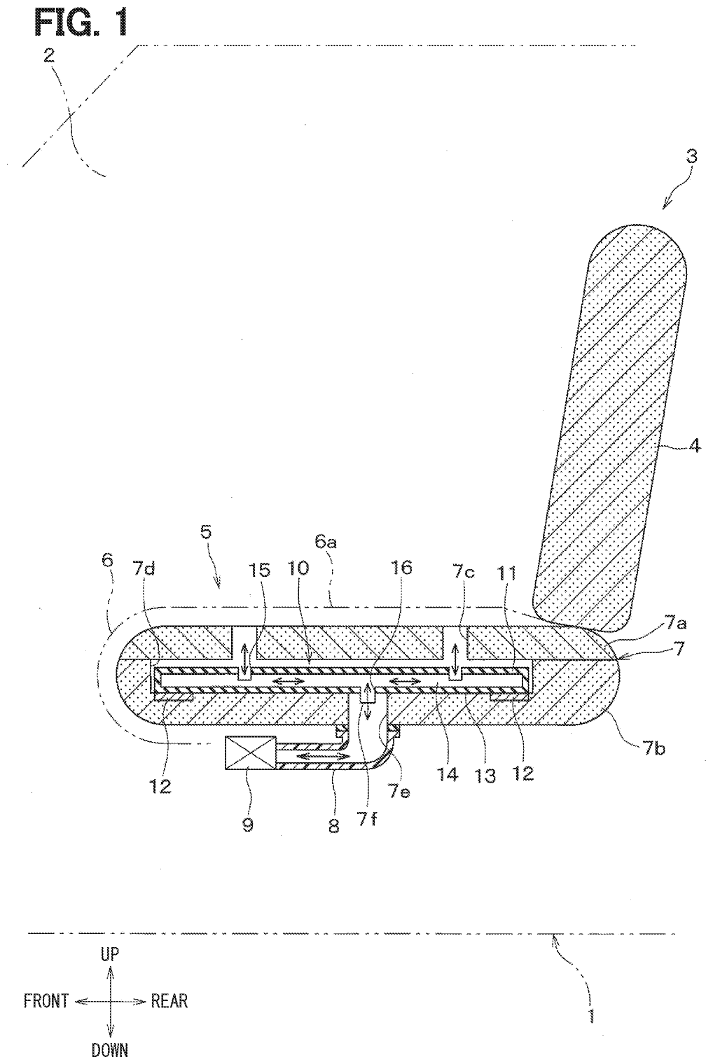

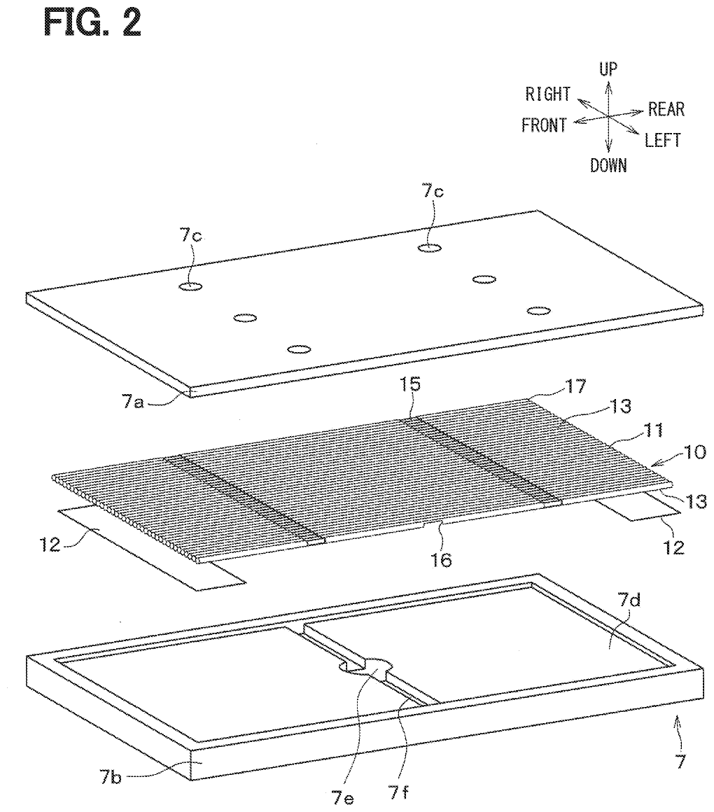

Hereinafter, an embodiment will be described with reference to FIGS. 1 and 2. Note that various modifications applicable to one embodiment are collectively described after explanation of the embodiment because understanding of the embodiment may be interfered when inserted in the middle of a series of explanations related to the embodiment. Note that when various modifications applicable one embodiment are inserted in a series of description of the one embodiment, the understanding of the one embodiment may be difficult; therefore, these will be collectively described after the description of the one embodiment.

To begin with, a relevant technology will be described first only for understanding the following embodiment. If the ventilation function and the heat generating function are needed for a seat, a two-layer structure of the air passage and the seat heater is arranged between the seat pad and the seat cover. In this case, since the seat heater is arranged between the air passage and the seat cover, the airflow resistance would increase. In addition, due to the increase in the number of parts and the number of assembling processes associated with the two-layer structure, the manufacturing cost and the weight of the device would increase.

The present disclosure has been made in view of such circumstances as described above. The present disclosure will provide a seat air conditioner having a good ventilation function and a heat generating function with a simplified structure.

According to one aspect of the present disclosure, a seat air conditioner is disposed in a seat pad for supporting a seated person and includes an airflow sheet that is formed in a sheet-like shape and defines an air passage therein. The airflow sheet has an air hole that opens toward a seat surface when the airflow sheet is disposed in the seat pad. Furthermore, the airflow sheet generates heat when energized.

In such a configuration, the airflow sheet has a ventilation function by discharging and drawing air through the air holes. Further, the airflow sheet generates heat when energized. In such a configuration, the airflow sheet can perform both a ventilation function and a heat generating function by the single airflow sheet that generates heat when energized. That is, the ventilation function and the heat generating function are integrated. Accordingly, it is possible to avoid an increase in an airflow resistance that would happen in the case of using a two-layer structure in which a sheet heater is provided in addition to the airflow sheet and both are stacked with each other. Thus, according to the configuration of the one aspect, the seat heating device can have a good ventilation property and a heat generation property with a simplified structure.

(Entire Configuration)

Referring to FIG. 1, a seat 3 is installed in a cabin 2 of a vehicle 1. In the present embodiment, the seat 3 is an automobile seat, and is mounted in the vehicle 1 which is an automobile.

Hereinafter, for convenience of description, the front, rear, left, right, upper, and lower directions in the present embodiment are defined as indicated by arrows in the drawings. The directions are provided only for convenience in order to simply describe the configuration of the embodiment. Therefore, “the lower direction” does not necessarily mean the direction in gravity. However, typically, when the vehicle 1 is stable on a horizontal plane, “the lower direction” matches or substantially matches the direction in gravity. Similarly, the left-right direction matches or substantially matches the vehicle width direction. However, the left-right direction does not necessarily mean the vehicle width direction. The same applies to the front-rear direction.

The seat 3 includes a backrest 4, a seat surface portion 5, and a cover 6. The backrest 4 extends obliquely upward from the rear end of the seat surface portion 5 so as to support an upper body of an occupant from a back side thereof when the occupant sits on the seat 3. The seat surface portion 5 is provided to support the buttocks and thighs of the occupant from a lower side thereof when the occupant sits on the seat 3.

The backrest portion 4 and the seat surface portion 5 have an outer surface that serves as the cover 6. For simplifying purposes, in FIG. 1, a portion of the cover 6 corresponding to the backrest 4 is omitted in the present embodiment. The cover 6 may be formed of a breathable fabric, for example, a cloth, natural leather with perforations, or synthetic leather with perforations. The seat surface 6a is an outer surface of the seat surface portion 5 that faces the buttocks and thighs of the occupant when the occupant sits on the seat 3. In other words, a portion of the surface of the cover 6 corresponds to the seat surface portion 5.

The seat surface portion 5 has the cover 6 and a seat pad 7. That is, in the present embodiment, the seat pad 7 constitutes a portion of the seat 3 installed in the cabin 2 of the vehicle 1.

The seat pad 7 is formed of a foamed polyurethane resin or the like having a high cushioning property so as to favorably support a seated person, that is, an occupant sitting on the seat 3. In the present embodiment, the seat pad 7 has a two-layer structure in which an upper pad 7a and a lower pad 7b are stacked with each other. The upper pad 7a and the lower pad 7b are made of the same material having the same characteristics. The “characteristics” include, for example, a hardness measured in accordance with an industrial standard such as JIS K 6400.

The upper pad 7a is arranged between the cover 6 and the lower pad 7b. In the upper pad 7a, a plurality of seat-side passages 7c through which air smoothly flows are formed in a vertical direction, that is, along the thickness direction of the upper pad 7a. “The air smoothly flows” means that a large flow resistance does not generate against the airflow flowing through the seat-side passage 7c. Hereinafter, the same applies to portions other than the seat-side passage 7c. More specifically, the seat-side passage 7c is a through-hole passing through the upper pad 7a in the thickness direction, and is open toward the cover 6, that is, the seat surface 6a.

The lower pad 7b is arranged below the upper pad 7a. In the present embodiment, the lower pad 7b defines a housing 7d therein. The housing 7d is a concave that opens toward the upper pad 7a, and is formed in a substantially rectangular shape in a plan view. In this specification, the “plan view” refers to viewing an object from above.

In the lower pad 7b, an air source passage 7e through which an air smoothly flows is formed in the vertical direction, that is, along the thickness direction of the lower pad 7b. The air source passage 7e is a through hole that passes through the lower pad 7b in the thickness direction, and opens at a substantially central portion of the housing 7d in the plan view.

A groove 7f through which an airflow flows is formed along the left-right direction substantially at the center in the front-rear direction of the housing 7d. The groove 7f is a concave portion that opens toward the upper pad 7a. The groove 7f is connected to a duct 8 via the air source passage 7e.

The duct 8 is a tubular member and connects an airflow generator 9 and the seat air conditioner 10. In the present embodiment, the duct 8 is arranged below the seat 3. The airflow generator 9 is, for example, a blower disposed below the seat 3. More specifically, the airflow generator 9 is a blower unit. Alternatively, the airflow generator 9 may be, for example, an air conditioner mounted in the vehicle 1.

(Configuration of the Seat Air Conditioner)

The seat air conditioner 10 is disposed in the seat pad 7 in the seat surface portion 5 to supply an airflow and to heat a seated person. Specifically, the seat air conditioner 10 includes an airflow sheet 11 and a pair of terminals 12. Hereinafter, the configuration of each part of the seat air conditioner 10 will be described with reference to FIGS. 1 and 2.

As shown in FIG. 2, the airflow sheet 11 is formed in a sheet-like shape and has a rectangular planar shape to be housed in the housing 7d. The “planar shape” refers to an outline of the sheet-like shape member when viewed in a direction perpendicular to a horizontal plan on which the sheet-like shape member is mounted so that the thickness direction of the sheet-like shape member is perpendicular to the horizontal plan. That is, the planar shape of the airflow sheet 11 is the same as the outline of the airflow sheet 11 in a plan view.

The airflow sheet 11 is configured to generate heat when energized by electrically connecting one of the pair of terminals 12 to a positive electrode of a power source (not shown) and the other of the pair of terminals 12 to a negative electrode of the power source. Specifically, the airflow sheet 11 is formed of a conductive resin (for example, a conductive elastomer or the like) that generates heat when energized. The “conductive resin” may also be referred to as a “synthetic resin constituting the resistance heating element.”

The airflow sheet 11 has a pair of airflow sheet surfaces 13 each having a rectangular planar shape. Each of the airflow sheet surfaces 13 is a surface that faces a horizontal surface of the airflow sheet 11 when the airflow sheet 11 is placed on the horizontal plane. That is, the sheet surfaces 13 are surfaces that constitute a top surface and a bottom surface.

The terminals 12 are disposed at positions corresponding to one edge portion and the other edge portion in an opposing direction of the rectangular planar shape of the airflow sheet 11. The “opposing direction” is a direction that defines an interval between a pair of opposite sides in a rectangle. That is, the opposing direction is a direction parallel to a virtual line orthogonal to both the pair of opposite sides. In the present embodiment, one of the pair of terminals 12 is arranged at a front end of the airflow sheet 1 and the other of the pair of terminals 12 is arranged at a rear end of the airflow sheet 11.

In the present embodiment, each of the terminals 12 is formed in a flat plate shape facing the airflow sheet surface 13. More specifically, each of the terminals 12 is a conductor plate extending in the left-right direction and is made of a good conductor such as copper. The terminals 12 are fixed on a bottom surface of the housing 7d. The terminal 12 is electrically connected to the airflow sheet 11 having conductivity itself and by coming into contact with, at a predetermined pressure, the airflow sheet surface 13 which is a conductive surface of the airflow sheet 11.

As shown in FIG. 1, the airflow sheet 11 has a plurality of air passages 14 through which an air flows. In the present embodiment, each of the air passages 14 extends along the front-rear direction so that an air mainly flows in the front-rear direction. Both ends of the air passage 14 in the front-rear direction are closed.

Further, the airflow sheet 11 has a plurality of air holes 15 through which an air flows. Each of the air holes 15 is a through hole that opens on the airflow seat surface 13 and is in communication with the air passage 14. The each of air holes 15 is open toward the seat surface 6a when the airflow sheet 11 is disposed in the seat pad 7 of the seat surface portion 5. That is, a space outside the airflow sheet 11 and the air passage 14 are in communication with each other via the air holes 15. Further, the air holes 15 are located at positions corresponding to the seat-side passage 7c in the front-rear direction. That is, the air holes 15 are arranged to face the seat-side passage 7c.

Further, the airflow sheet 11 has a plurality of communication holes 16 through which an air flows smoothly. Each of the communication holes 16 is a through hole that opens at one side of the airflow sheet surface 13 opposite to the other side of the sheet surface 13 where the air holes 15 are formed. Each of the communication holes 16 is in communication with the air passage 14. The communication holes 16 are located at a position corresponding to the groove 7f in the front-rear direction to be in communication with the groove 7f when the airflow sheet 11 is disposed in the seat pad 7 in the seat surface portion 5. That is, the communication holes 16 face the groove 7f.

In the present embodiment, the airflow sheet 11 is formed by arranging a plurality of air tubes 17 in parallel with each other. The plurality of air tubes 17 are made of conductive resin. Each of the air tubes 17 is a tube having the air passage 14 therein and is formed into a cylindrical shape. Each of the plurality of air tubes 17 extends in the front-rear direction. The plurality of air tubes 17 are arranged in the left-right direction. That is, the airflow sheet 11 has a structure in which the plurality of air passages 14 extending in the front-rear direction are arranged in parallel with each other. Further, the airflow sheet 11 is configured such that an energizing direction is the same as the extending direction of the air tubes 17.

Specifically, in this embodiment, the plurality of air tubes 17 are integrated by connecting the two air tubes 17 that are adjacent to each other in the left-right direction. For example, the plurality of air tubes 17 may be seamlessly integrated with each other. For this reason, the airflow seat surface 13 has a shape in which a plurality of semi-columnar surfaces are arranged in parallel and are smoothly connected to each other. Further, in each of the air tubes 17, a cutout defining the air hole 15 is formed at the same position in the front-rear direction as cutouts of the other air tubes 17. Further, in each of the air tubes 17, a cutout defining the communication hole 16 is formed at the same position in the front-rear direction as cutouts of the other air tubes 17.

(Operation)

Hereinafter, an outline of an operation of the seat air conditioner 10 according to the present embodiment will be described together with advantages achieved by the configuration of the present embodiment with reference to FIGS. 1 and 2.

For example, an air may be blown from the airflow source toward the seat air conditioner 10. In this case, an airflow in a blowing direction is supplied from the airflow source 9 to the seat air conditioner 10 via the duct 8. Then, due to the airflow, airflows are generated in which air flows into the air passages 14 in the airflow sheet 11 through the air source passage 7e, the groove 7f, and the communication hole 16.

As a result, airflows are generated in which air flows out of the airflow sheet 11 from the air passages 14 through the air holes 15. That is, an airflow is discharged from the air holes 15 toward the seat surface 6a. The airflows discharged from the air holes 15 toward the seat surface 6a pass through the seat-side passage 7c and the cover 6 having air permeability. Then, the airflows reach the cabin 2. In this way, air is blown to the seated person.

Furthermore, an air may be sucked in by the airflow source 9. In this case, airflows toward the airflow source 9 may be generated from the air conditioner 10. That is, airflows in a drawing direction is supplied from the airflow source 9 to the seat air conditioner 10 via the duct 8. Due to the airflow, airflows are generated to flow out of the air passages 14 in the airflow sheet 11 via the communication holes 16, the groove 7 f, and the air passage 7e. That is, air is sucked from the air passages 14 in the airflow sheet 11.

As a result, airflows are generated to flow into the air passages 14 in the airflow sheet 11 through the seat-side passage 7c and the air hole 15. Then, a negative pressure is generated in the seat-side passage 7c. Accordingly, the air around the seat surface 6a passes through the permeable cover 6 and is sucked into the airflow sheet 11. In this way, by sucking the air between the seated person and the seat 3, it is possible to effectively eliminate stuffiness in the seated portion.

Further, the airflow sheet 11 is energized through the pair of terminals 12. Then, the airflow sheet 11 generates heat. Therefore, a heating operation for the seated person is performed. The heating operation may be performed at a different timing from the blowing operation or the drawing operation, or at the same timing as the blowing operation or the drawing operation. In particular, when the blowing operation and the heating operation are performed at the same time, an air in the air passage 14 is heated by energizing the airflow sheet 11. By supplying such a heated air to the occupant through the air hole 15, heating of the occupant can be effectively realized together with radiant heat generated from the airflow sheet 11.

As described above, in the embodiment, the airflow sheet has a ventilation function by discharging and drawing air through the air holes 15. Further, the airflow sheet 11 generates heat when energized. In such a configuration, the airflow sheet 11 can perform both the ventilation function and the heat generating function by the single airflow sheet 11 that generates heat when energized. That is, the ventilation function and the heat generating function are integrated.

If a two-layer structure where a sheet heater and the airflow sheet 11 are disposed between the seat surface 6a and the seat pad 7 is used, an airflow resistance would increase due to the existence of the sheet heater. On the contrary, in the configuration of the present embodiment, the ventilation function and the heating function are realized by the single airflow sheet 11, and thus the above-described increase in the airflow resistance can be avoided.

As described above, according to the configuration, the seat heating device can have a good ventilation property and a heat generation property with a simplified structure. From such a viewpoint, the seat air conditioner 10 may be referred to as a “seat blower” or a “seat airflow generator” having a heating function.

Further, in the present embodiment, the airflow sheet 11 is formed of a conductive resin that generates heat when energized. In such a configuration, the airflow sheet 11 is configured by forming the airflow sheet 11 having a ventilation function from a conductive resin. Therefore, the single airflow sheet 11 in which the ventilation function and the heat generating function are well integrated can be realized at a low cost.

Further, in the configuration of the present embodiment, the airflow sheet 11 is formed by arranging the plurality of air tubes 17 in parallel each of which is formed in a tube shape and defines the air passage 14 therein. More specifically, in this embodiment, the airflow sheet 11 has a structure in which the plurality of air tubes 17 are integrated by connecting the two air tubes 17 that are adjacent to each other in the left-right direction.

In such a configuration, the airflow sheet 11 has a structure in which the plurality of air passages 14 defined in the air tubes 17 are arranged in parallel with each other. Therefore, it is possible to realize the single airflow sheet 11 in which the ventilation function and the heat generating function are well integrated with a simple configuration.

Further, in the present embodiment, the airflow sheet 11 has a rectangular planar shape. The terminals 12 for energizing the airflow sheet 11 are disposed at positions corresponding to one edge portion and the other edge portion in an opposing direction of the rectangular planar shape of the airflow sheet 11. In such a configuration, by increasing the distance between the pair of terminals 12 as much as possible, it is possible to make the energized heat generation area of the airflow sheet 11 as large as possible.

Further, in the configuration of the present embodiment, the terminals 12 for energizing the airflow sheet 11 are formed in a flat plate shape facing the airflow sheet surface 13 which is a surface of the airflow sheet 11. In such a configuration, the electric connection between the airflow sheet 11 and the terminals 12 is formed by having the flat terminals 12 face and come into contact with the airflow sheet surface 13 which is the surface of the airflow sheet 11. Therefore, the electric connection between the airflow sheet 11 and the terminals 12 can be formed by a simple configuration.

In the present embodiment, the seat pad 7 constitutes the seat 3 installed in the cabin 2 of the vehicle 1. In such a configuration, by installing the airflow sheet 11 into the seat pad 7 that configures the seat 3 installed in the cabin 2 of the vehicle 1, the heating body 11 can supply an airflow and heat to an occupant of the vehicle 1. Therefore, it is possible to provide a ventilation function and a heat generating function in a seat of a vehicle such as an automobile while minimizing the complexity of the device configuration.

(Modifications)

The present disclosure is not necessarily limited to the above embodiment. Thus, it is possible to appropriately change the above-described embodiment. Representative modifications will be described below. In the following description of the modifications, parts different from the above embodiment will be mainly described. In addition, in the above-described embodiment and the modifications, the same reference numerals are given to the same or equivalent parts. Therefore, in the description of the following modifications, regarding components having the same reference numerals as the components of the above-described embodiment, the description in the above-described embodiment can be appropriately cited unless there is a technical inconsistency or a specific additional explanation.

The concepts of the front, rear, left, right, up, and down directions in the description and the drawings are set only for simply describing the configuration of the embodiment. Accordingly, the present disclosure is not necessarily limited to such a directional concept.

For example, as shown in FIG. 1, when the seat 3 is installed “forward,” the left-right direction is the same or substantially the same as the vehicle width direction. On the contrary, if the seat 3 is installed “sideways,” the front-rear direction is the same or substantially the same as the vehicle width direction. If the seat 3 is installed “backward,” the front-back direction is reversed. The same applies to the modifications described below.

The structure of the seat 3 is not particularly limited to the above-described configuration. For example, the seat 3 may be a front seat or a rear seat. The backrest 4 may be adjustable or non-adjustable in reclining angle. The backrest 4 may be equipped with a headrest that supports the head of a seated person. Alternatively, the seat 3 may not have the backrest 4.

In the above embodiment, the airflow sheet 11 is mounted in the seat pad 7 by being housed in the housing 7d defined in the lower pad 7b. However, the present disclosure is not necessarily limited to such a configuration.

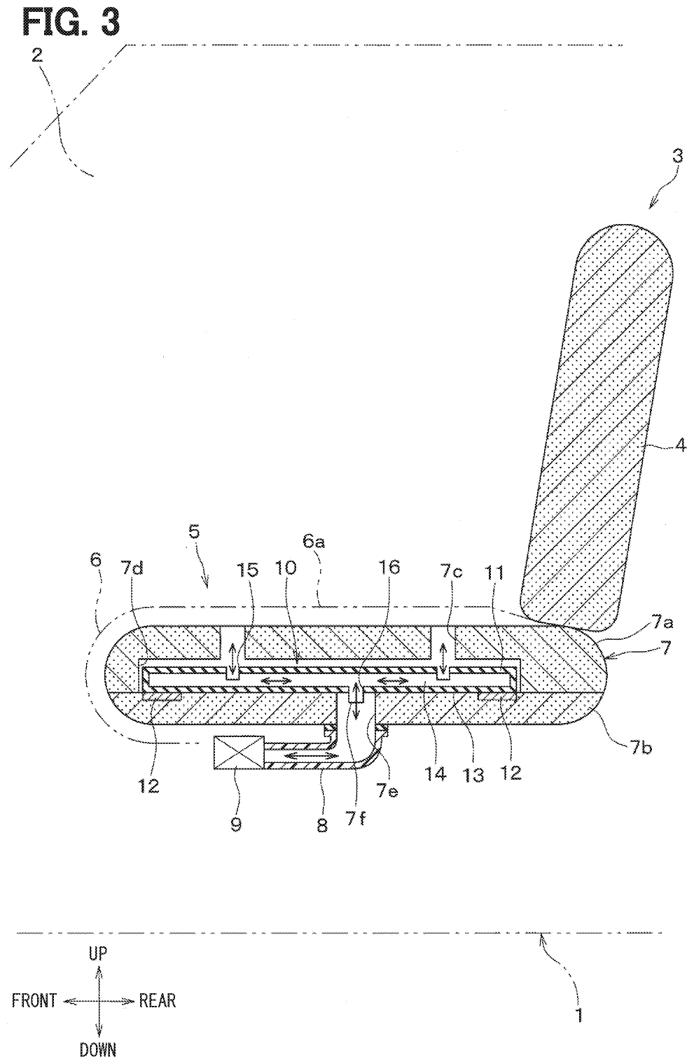

That is, for example, as shown in FIG. 3, the housing portion 7d for housing the airflow sheet 11 may be provided in the upper pad 7a so as to open toward the lower pad 7b. In the above embodiment and the present modification, the skin portion 6 may be integrated with an outer surface of the seat pad 7.

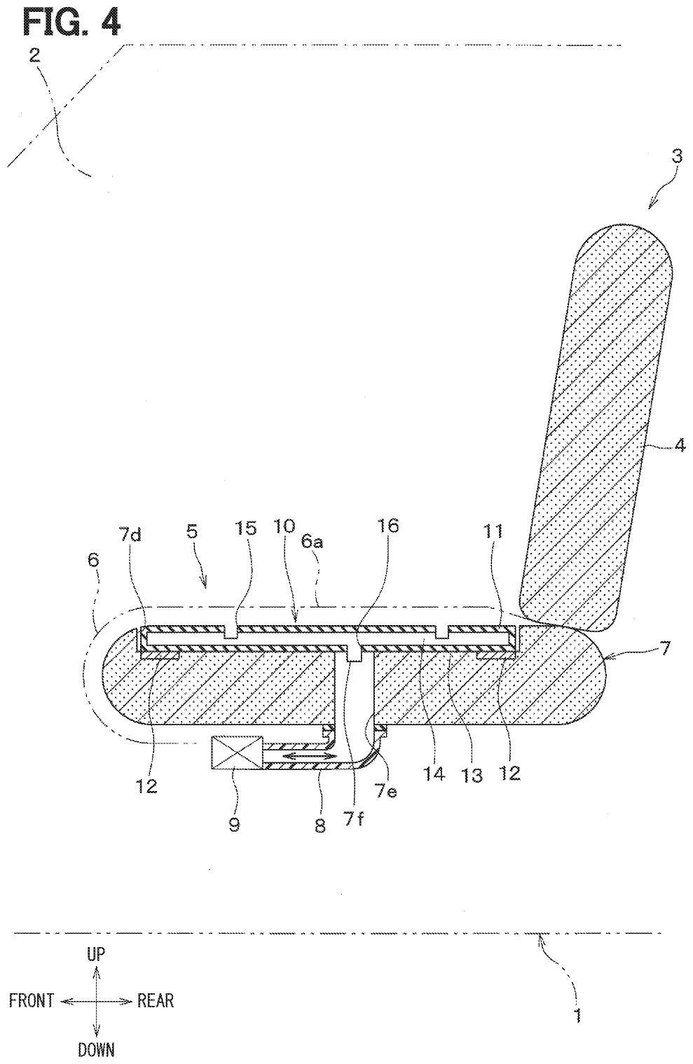

Alternatively, the airflow sheet 11 may be arranged between the cover 6 and the seat pad 7 as shown in FIG. 4. In this case, the seat pad 7 may have an integral structure that is not vertically separated. Further, preferably, the housing 7d may be formed on the upper surface of the seat pad 7 facing the cover 6. The housing 7d is a concave that opens toward the cover 6 and is formed to house the airflow sheet 11. As shown in FIG. 4, the housing 7d may be formed on the upper surface of the seat pad 7, and then the airflow sheet 11 is housed in the housing 7d. As a result, deterioration in seat comfort due to the existence of the convex portion on the seating surface 6a can be suppressed as much as possible. As described above, it is not essential to form the housing 7d on the upper surface of the seat pad 7.

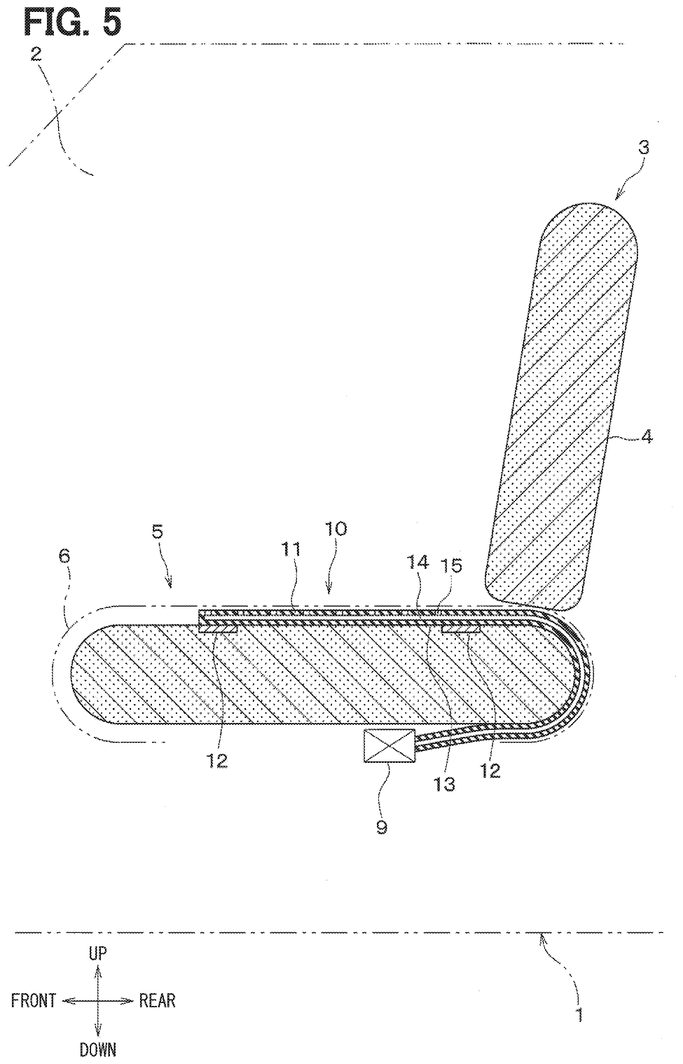

The connection of the airflow path between the airflow generator 9 and the seat air conditioner 10 may be performed without penetrating the seat pad 7. That is, for example, as shown in FIG. 5, the airflow sheet 11 is provided to extend from the upper surface to the bottom surface of the lower pad 7b through the rear end of the lower pad 7b and then is connected to the airflow generator 9 at the bottom surface of the lower pad 7b. In this case, the energization area between the pair of terminals 12 in the airflow sheet 11 may be an area corresponding to the seat surface 6a, as shown in FIG. 5. In this case as well, as shown in FIG. 4, a housing 7d may be formed on the upper surface of the seat pad 7. That is, the energization area between the pair of terminals 12 in the airflow sheet 11 may be housed in the housing 7d formed on the upper surface of the seat pad 7.

Further, in the above-described embodiment, the airflow sheet 11 is formed of a conductive resin that generates heat when energized. However, the present disclosure is not necessarily limited to such a configuration.

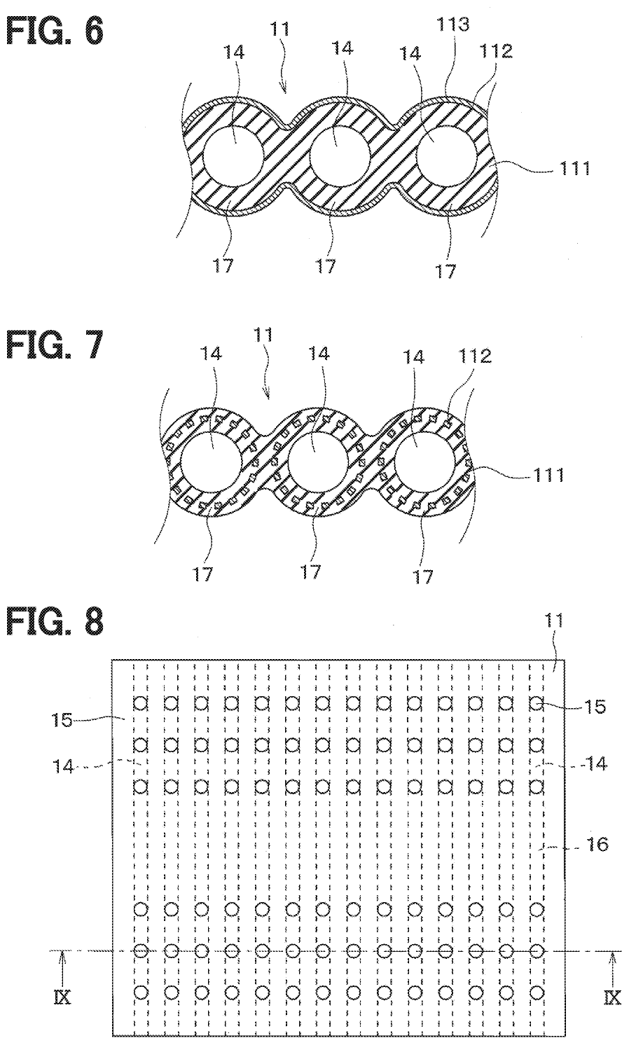

For example, as shown in FIG. 6, an airflow sheet 11 as a modified example includes a main body 111 and a heating body 112. The main body 111 is made of an insulating resin. More specifically, the main body 111 is formed by arranging a plurality of air tubes 17 made of insulating resin in parallel to be integrally formed with each other.

The heating body 112 is formed in a film shape with an electric resistor that generates heat when energized. The heating body 112 is joined to a main body surface 113 to be in close contact with the main body surface 113 which is a surface of the main body 111. Specifically, for example, the heating body 112 can be formed by forming an electric resistor film on the main body surface 113 in a dry or wet film formation method. Alternatively, the heating body 112 can be formed by forming an electric resistor film on the main body surface 113 by bonding.

In the present modification, the airflow sheet 11 is formed by forming the heating body 112 which is an electric resistor film on the main body surface 113 which is a surface of the main body 111 made of an insulating resin. Therefore, it is possible to realize the single airflow sheet 11 in which the ventilation function and the heat generating function are well integrated with a simple configuration.

Alternatively, as shown in FIG. 7, an airflow sheet 11 as another modification includes a main body 111 and a heating body 112. The main body 111 is made of an insulating resin. More specifically, the main body 111 is formed by arranging the plurality of air tubes 17 made of insulating resin in parallel to be integrally formed with each other.

The heating body 112 is formed in a linear shape, i.e., a wire shape, with an electric resistor that generates heat when energized. The heating body 112 is embedded in the main body 111. Specifically, for example, the heating body 112 is formed in a mesh shape and a cylindrical shape by knitting a large number of linear electric resistors. In the main body 111, an insulating layer covers each of the plurality of linear electric resistors by impregnating an insulating material such as an insulating elastomer into the mesh-like, cylindrical heating element 112.

In the present modification, the airflow sheet 11 is formed by embedding the heating body 112, which is a linear-shaped electric resistor, into the main body 111 made of an insulating resin. Therefore, it is possible to realize the single airflow sheet 11 in which the ventilation function and the heat generating function are well integrated with a simple configuration.

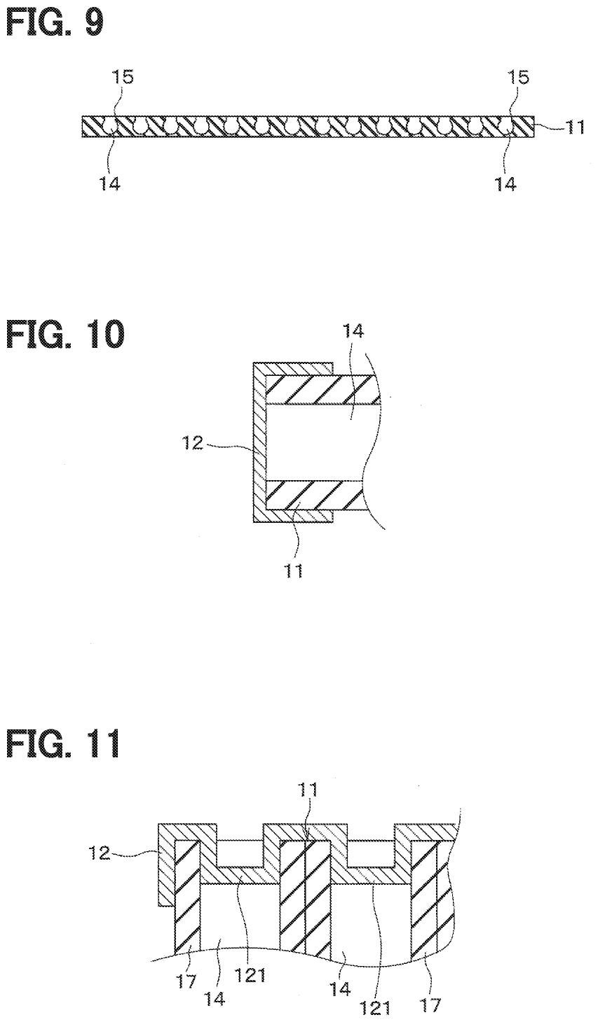

In the above embodiment and modifications, the airflow sheet 11 is formed by arranging the plurality of air tubes 17 in parallel to be integrally formed with each other. However, the present disclosure is not necessarily limited to such a configuration. For example, the airflow sheet 11 may be formed by forming a plurality of air passages 14 in a single plate-shaped member, as shown in FIGS. 8 and 9.

In the above-described embodiment and modifications, the terminals 12 for energizing the airflow sheet 11 are formed in a flat plate shape facing the airflow sheet surface 13 which is a surface of the airflow sheet 11. However, the present disclosure is not necessarily limited to such a configuration.

Specifically, for example, as shown in FIG. 10, the terminal 12 may have a U-shaped cross section so as to house an end of the airflow sheet 11 in the opposing direction. In such a configuration, the electrical connection between the airflow sheet 11 and the terminal 12 is formed by housing the end of the airflow sheet 11 in the opposing direction in the terminal 12 having the U-shaped cross section. Therefore, the electrical connection between the airflow sheet 11 and the terminals 12 can be reliably formed. The “U-shape” can also be expressed as “C-shape” or “square bracket shape”.

Alternatively, for example, as shown in FIG. 11, the terminal 12 may have protrusions 121. Each of the protrusions 121 is formed at an end of the airflow sheet 11 in the opposing direction and protrudes along the extending direction of the air passage 14 so that the protrusion 121 is inserted into the airflow sheet 11, that is, into the air passage 14.

More specifically, the airflow sheet 11 in the resent modification is formed by arranging a plurality of air tubes 17 made of insulating resin in parallel to be integrally formed with each other. The terminal 12 has the same number of protrusions 121 as the number of the air tubes 17. Each of the plurality of protrusions 121 is inserted into the air passage 14 at the end of the corresponding air tube 17.

In such a configuration, the electrical connection between the airflow sheet 11 and the terminal 12 is formed by inserting the protrusions 121 of the terminal 12 into the airflow sheet 11 at the end in the opposing direction of the airflow sheet 11. Therefore, the electrical connection between the airflow sheet 11 and the terminals 12 can be reliably established.

The airflow generator 9 may be a blower disposed close to the seat 3. More specifically, the airflow generator 3 may be a blower unit. In this case, it can be understood that the seat air conditioner 10 includes the airflow sheet 11 and the airflow generator 9 that supplies an airflow to the airflow sheet 11.

The flow direction of the airflow in the air passage 14 and the energizing direction, i.e., the current flow direction in the airflow sheet 11, may be parallel as in the above-described embodiment or may cross each other.

In the above-described embodiment and each of the modifications, the seat air conditioner 10 is disposed in the seat surface portion 5. However, the present disclosure is not necessarily limited to such a configuration. That is, the seat air conditioner 10 may be disposed in the backrest 4 instead of the seat surface portion 5 or together with the seat surface portion 5. When the seat air conditioner 10 is disposed in the backrest 4, the backrest 4 may be configured in the same manner as the seat surface 5 in the above embodiment and each of the modifications. Therefore, in order to avoid redundant description, the illustration and description of the configuration of the backrest 4 when the seat air conditioner 10 is disposed in the backrest 4 will be omitted in this specification.

In the above description, a plurality of elements formed integrally with each other without seam may be formed by bonding separate members together. Similarly, a plurality of elements formed by bonding separate members together may be formed integrally with each other with no seam.

In the above description, a plurality of elements formed of the same material may be formed of different materials. Similarly, a plurality of elements formed of different materials may be formed of the same material.

The modifications are also not necessarily limited to the above examples. Further, a plurality of modifications may be combined together. Furthermore, all or a part of the above-described embodiments and all or a part of the modifications may be combined with each other.

The constituent element(s) of each of the above embodiments and the above modifications is/are not necessarily essential unless it is specifically stated that the constituent element(s) is/are essential in the above embodiments, or unless the constituent element(s) is/are obviously essential in principle. In addition, in the case where the number of the constituent element(s), the value, the amount, the range, and/or the like is specified, the present disclosure is not necessarily limited to the number of the constituent element(s), the value, the amount, and/or the like specified in the embodiment unless the number of the constituent element(s), the value, the amount, and/or the like is indicated as essential or is obviously essential in view of the principle. Similarly, in the case where the shape, the direction, the positional relationship, and/or the like of the constituent element(s) is specified, the present disclosure is not necessarily limited to the shape, the direction, the positional relationship, and/or the like unless the shape, the direction, the positional relationship, and/or the like is/are indicated as essential or is/are obviously essential in principle.

(Overview)

Hereinafter, various aspects of the present disclosure, which are indicated by part or all of the disclosure according to the above-described embodiment and modified examples, will be described.

In a first aspect, the airflow sheet is configured to generate heat when energized. In such a configuration, the airflow sheet has a ventilation function by discharging or drawing air through the air holes. Further, the airflow sheet generates heat when energized. That is, the ventilation function and the heat generating function are integrated by the single airflow sheet. Thus, according to the configuration, the seat heating device can have a good ventilation property and a heat generation property with a simplified structure.

In a second aspect, the airflow sheet is formed of a conductive resin that generates heat when energized. In such a configuration, the airflow sheet is configured by forming the airflow sheet having a ventilation function from a conductive resin. Therefore, the single airflow sheet in which the ventilation function and the heat generating function are well integrated can be realized at a low cost.

In a third aspect, the airflow sheet includes a main body and a heating body. The main body is made of an insulating resin. The heating body is made of an electric resistor that generates heat when energized and that is formed into a film shape. The heating body is joined to, and in close contact with, a main surface that is a surface of the main body. In such a configuration, the airflow sheet is formed by forming the heating body which is an electric resistor film on the main body surface which is a surface of the main body made of an insulating resin. Therefore, it is possible to realize the single airflow sheet in which the ventilation function and the heat generating function are well integrated with a simple configuration.

In a fourth aspect, the airflow sheet includes a main body and a heating body. The main body is made of an insulating resin. The heating body is formed into a linear shape and is made of an electric resistor that generates heat when energized. The heating body is embedded in the main body. In such a configuration, the airflow sheet is formed by embedding the heating body, which is a linear-shaped electric resistor, into the main body made of an insulating resin. Therefore, it is possible to realize the single airflow sheet in which the ventilation function and the heat generating function are well integrated with a simple configuration.

In a fifth aspect, the airflow sheet is formed by arranging in parallel the plurality of air tubes each formed in a tube shape and defining the air passage therein. In such a configuration, the airflow sheet has a structure in which the plurality of air passages defined in the inside space of the air tube are arranged in parallel with each other. Therefore, it is possible to realize the single airflow sheet in which the ventilation function and the heat generating function are well integrated with a simple configuration.

In a sixth aspect, the airflow sheet is formed in a rectangular shape. The terminals for energizing the airflow sheet are disposed at positions corresponding to one edge portion and the other edge portion in an opposing direction of the rectangular planar shape of the airflow sheet. In such a configuration, by increasing the distance between the pair of terminals as much as possible, it is possible to make the energized heat generation area of the airflow sheet as large as possible.

In a seventh aspect, the terminals for energizing the airflow sheet are formed in a flat plate shape facing the airflow sheet surface which is a surface of the airflow sheet. In such a configuration, the electrical connection between the airflow sheet and the terminals is formed by having the flat terminals face and come into contact with the airflow sheet surface which is the surface of the airflow sheet. Therefore, the electrical connection between the airflow sheet and the terminals can be formed by a simple configuration.

In an eighth aspect, the terminal for energizing the airflow sheet has a U-shaped cross section so as to house an end of the airflow sheet in the opposing direction. In such a configuration, the electrical connection between the airflow sheet and the terminal is formed by housing the end of the airflow sheet in the opposing direction in the terminal having the U-shaped cross section. Therefore, the electrical connection between the airflow sheet and the terminals can be reliably formed.

In a ninth aspect, the terminal for energizing the airflow sheet has a protrusion. The protrusion is formed at an end of the airflow sheet in the opposing direction so as to be inserted into the airflow sheet. In such a configuration, the electrical connection between the airflow sheet and the terminal is formed by inserting the protrusions of the terminal into the airflow sheet at the end in the opposing direction of the airflow sheet. Therefore, the electrical connection between the airflow sheet and the terminals can be reliably formed.

In a tenth aspect, the seat pad constitutes a portion of the seat installed in the cabin of the vehicle. In such a configuration, by installing the airflow sheet in the seat pad that configures the seat installed in the cabin of the vehicle, the heating body can supply an airflow and/or heat to an occupant of the vehicle. Therefore, it is possible to provide a ventilation function and a heat generation function in a seat of a vehicle such as an automobile while minimizing the complexity of the device configuration.

1. A seat air conditioner that is disposed in a seat pad for supporting a seated person, the seat air conditioner comprising:
an airflow sheet that is formed in a sheet-like shape and defines an air passage therein, the airflow sheet having an air hole that opens toward a seat surface when the airflow sheet is disposed in the seat pad, wherein
the airflow sheet generates heat when energized.

2. The seat air conditioner according to claim 1, wherein
the airflow sheet is formed by defining the air passage and the air hole in a conductive resin that generates heat when energized.

3. The seat air conditioner according to claim 1, wherein
the airflow sheet includes:
a main body that is made of an insulating resin; and
a heating body that is formed in a film shape and is made of an electric resistor that generates heat when energized, the heating body being joined to, and in close contact with, a main surface that is a surface of the main body.

4. The seat air conditioner according to claim 1, wherein
the airflow sheet includes:
a main body that is made of an insulating resin; and
a heating body that is formed in a linear shape and is made of an electric resistor that generates heat when energized, the heating body being embedded in the main body.

5. The seat air conditioner according to claim 1, wherein
the airflow sheet is formed by arranging a plurality of air tubes in parallel with each other, and
each of the plurality of air tubes is formed in a tubular shape and defines the air passage therein.

6. The seat air conditioner according to claim 1, wherein
the airflow sheet is formed in a rectangular shape having two edge portions that face each other in an opposing direction of the rectangular shape, and
a terminal for energizing the airflow sheet is disposed at each of the two edge portions of the airflow sheet.

7. The seat air conditioner according to claim 1, wherein
a terminal for energizing the airflow sheet is formed in a plate shape that faces an airflow sheet surface that is a surface of the airflow sheet.

8. The seat air conditioner according to claim 6, wherein
the terminal has a U-shaped cross-section to house a corresponding one of the two edge portions of the airflow sheet.

9. The seat air conditioner according to claim 6, wherein
the terminal includes a protrusion that is inserted into the airflow sheet at a corresponding one of the two edge portions of the airflow sheet.

10. The seat air conditioner according to claim 1, wherein
the seat pad constitutes a part of a seat installed in a cabin of the vehicle.
